(19) United States
(12) Patent Application Publication
(10) Pub. No.: US 2009/0190027 A1
(43) Pub. Date: Jul. 30, 2009

(54) METHOD AND SYSTEM FOR ASPECT RATIO CONTROL

(75) Inventors: David J. Delia, Lagrangeville, NY (US); Wayne M. Delia, Poughkeepsie, NY (US)

Correspondence Address: CANTOR COLBURN LLP - IBM FISHKILL, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/020,070

(22) Filed: Jan. 25, 2008

(51) Int. Cl. H04N 11/20

(52) U.S. Cl. 348/445

(57) ABSTRACT

A method for viewer based control of video display aspect ratios, the method includes: applying an initial video display aspect ratio to a selected signal source; determining if the selected signal source has a viewer assigned video display aspect ratio; modifying the initial video display aspect ratio of the selected signal source in response to the viewer assigned video display aspect ratio; wherein the viewer assigned video display aspect ratio is a subset of one or more of the viewer assigned video display aspect ratios that are stored in a non-volatile memory medium; wherein the one or more viewer assigned video display aspect ratios are each individually associated with a signal source; and wherein a viewer assigned video display aspect ratio is retrieved from the non-volatile memory medium in response to the selection of an associated signal source.

### BACKGROUND OF THE INVENTION

1. Field of the Invention

This invention relates generally to television and multimedia devices, and more particularly to a method, apparatus, and system for user based control of video display aspect ratios in response to a channel or input selection.

2. Description of the Related Art

Digital television (DTV) is a telecommunication system for broadcasting and receiving moving pictures and sound by means of a digital signal, in contrast to an analog signal used by analog (traditional) standard definition TV (SDTV). DTV utilizes the digital modulation of analog signal data, which is digitally compressed prior to recording or broadcast. The digitally compressed signal requires decoding by a specially designed receiver within a television set, or a standard receiver with a set-top box, or a PC fitted with a television card. Digital television has several advantages over traditional analog TV, the most significant being that digital channels take up less bandwidth space. The reduced bandwidth of a digital broadcast signal enables digital broadcasters to provide more digital channels in the same space, provide High-Definition (HD) digital service, or provide other non-television services such as pay-multimedia services or interactive services. Digital television also permits special services such as multicasting (more than one program on the same channel), electronic program guides, and program identification.

In addition, the transition from National Television System Committee (NTSC) SDTV to Advanced Television Systems Committee (ATSC) high definition broadcasting has introduced programming available in widescreen 16:9 aspect ratios versus the traditional 4:3 aspect ratio. Aspect ratio is the measure of an image's width (w) to its height (h) and is generally expressed as (w:h).

Widescreen television and video display monitors are currently among the most popular components of home entertainment systems. Widescreen monitors are capable of displaying different formats of video broadcasts, particularly “high-definition” (HDTV) signals of extremely clear picture quality. HDTV channels conform to international standards of broadcast transmission of 720 or 1080 scan lines, and generally have a default aspect ratio of 16:9. The 16:9 aspect ratio is the default screen size when a HD channel is selected, and the picture typically fills the entire widescreen. Widescreen displays are also capable of showing standard-definition television (SDTV) in the traditional aspect ratio of 12:9 (4:3). However, the 12:9 aspect ratio does not fill the entire widescreen display of 16:9.

The Federal Communications Commission (FCC), the branch of the United States (U.S.) government that regulates the television and radio broadcast industries, has mandated that all U.S. television broadcasts will be exclusively digital as of Feb. 17, 2009. Furthermore, as of Mar. 1, 2007, all new television sets that can receive signals over-the-air, including pocket-sized portable televisions, must include digital or HDTV tuners so they can receive digital broadcasts.

### SUMMARY OF THE INVENTION

Embodiments of the present invention include a method, article, and system for viewer based control of video display aspect ratios, the method includes: applying an initial video display aspect ratio to a selected signal source; determining if the selected signal source has a viewer assigned video display aspect ratio; modifying the initial video display aspect ratio of the selected signal source in response to the viewer assigned video display aspect ratio; wherein the viewer assigned video display aspect ratio is a subset of one or more of the viewer assigned video display aspect ratios that are stored in a non-volatile memory medium; wherein the one or more viewer assigned video display aspect ratios are each individually associated with a signal source; and wherein a viewer assigned video display aspect ratio is retrieved from the non-volatile memory medium in response to the selection of an associated signal source.

An article comprising one or more computer-readable storage media containing instructions that when executed by a computer enables viewer based control of video display aspect ratios; wherein the method further includes: applying an initial video display aspect ratio to a selected signal source; determining if the selected signal source has a viewer assigned video display aspect ratio; modifying the initial video display aspect ratio of the selected signal source in response to the viewer assigned video display aspect ratio; wherein the viewer assigned video display aspect ratio is a subset of one or more of the viewer assigned video display aspect ratios that are stored in a non-volatile memory medium; wherein the one or more viewer assigned video display aspect ratios are each individually associated with a signal source; and wherein a viewer assigned video display aspect ratio is retrieved from the non-volatile memory medium in response to the selection of an associated signal source.

A system configured for viewer based control of video display aspect ratios, the system includes: a video display configured for showing multiple aspect ratios and a graphical user interface; control logic electrically connected to a non-volatile storage medium; wherein the control logic is configured to: apply an initial video display aspect ratio to a selected signal source; determine if the selected signal source has a viewer assigned video display aspect ratio; modify the initial video display aspect ratio of the selected signal source in response to the viewer assigned video display aspect ratio; wherein the viewer assigned video display aspect ratio is a subset of one or more of the viewer assigned video display aspect ratios that are stored in the non-volatile storage medium; wherein the one or more viewer assigned video display aspect ratios are each individually associated with a signal source; and wherein a viewer assigned video display aspect ratio is retrieved from the non-volatile storage medium in response to the selection of an associated signal source.

### TECHNICAL EFFECTS

As a result of the summarized invention, a solution is technically achieved for a method, article, and system for user based control of video display aspect ratios in response to a channel or input selection.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary system for implementing an embodiment of the invention.

FIG. 2 is a flowchart illustrating the selection of viewer defined display aspect ratios based on predefined parameters in a non-volatile database according to embodiments of the invention.

The detailed description explains the preferred embodiments of the invention, together with advantages and features, by way of example with reference to the drawings.

### DETAILED DESCRIPTION

Embodiments of the invention provide a method, article, and system for user based control of video display aspect ratios in response to a channel or input selection. When a widescreen display is receiving an SDTV channel, a typical initial display arrangement is for the 4:3 aspect ratio SDTV picture to be centered in the widescreen display with vertical side bars of a neutral color (sometimes called “pillarbox” display) on either side of the SDTV picture. Each side bar is 12.5% of the total horizontal width of the widescreen display. From this initial configuration, various user-selectable display options are available from an on-screen menu, accessible using the remote control. These options include the capability of stretching the 4:3 aspect ratio picture to fill the 16:9 display, or zooming in on the picture in its original aspect ratio, cutting off horizontal sections of the picture at the top and bottom to extend the SDTV picture to the full width of the display. However, with current widescreen display units these selected display options are in effect only for the time the channel is displayed. If another channel is selected, followed by a return to the original channel, the selected display modifications are lost. In addition, when the widescreen display units are turned off, the user settings for the aspect ratios are lost, and have to be reset the next time the user turns on the set.

Similarly, traditional SDTV and analog television displays supporting the aspect ratio of 4:3 are unable to display a 16:9 aspect ratio without either some loss of picture along the excess length of either side, or the need to display the entire 16:9 aspect ratio signal in what is familiarly known as the “letterbox” format, featuring horizontal bars at the top and bottom of the display, each bar representing 12.5% of the total available vertical height of the display. In addition, some traditional-sized display units provide the ability to adjust display parameters to either vertically stretch the picture to expand to the total height of the standard screen, or to zoom in on the picture, sacrificing vertical strips on either side of the picture to preserve the original aspect ratio of the widescreen picture. Another technique available is known as “anamorphic widescreen adjustment,” a video encoding technique used to optimize the vertical picture resolution of widescreen images by squeezing the images horizontally into a 4:3 native aspect ratio suitable for viewing on standard size television displays. Again, as is the case with widescreen display units, any modifications made to the display parameters of a particular channel on a current SDTV are lost as soon as the channel is changed, or if the television is powered off.

Embodiments of the invention provide a viewer with the ability to specify aspect ratio display parameters for particular channels and inputs, and to have these parameters remain in effect while other channels or inputs are selected. Embodiments of the invention store user specified aspect ratio settings for individual channels and monitor inputs in a database that is stored in a non-volatile memory. The non-volatile database of display settings remains in effect even when the television is powered off.

Embodiments of the invention may consist of a logic chip or processor chip coupled to non-volatile memory embedded in a channel tuner of a set top box for over the air signals, cable, or satellite reception. Alternatively, the processor and non-volatile memory for carrying out embodiments of the invention may be integrated with a built-in tuner and input selector of a display unit. User defined parameters for selected channels and inputs are stored in a database held in the non-volatile memory, and the processor contains programming code to facilitate the selection of display aspect ratios based on the user defined parameters. In embodiments of the invention an on screen graphical user interface (GUI) may be implemented to facilitate the selection and setting of user defined display aspect ratios. Subsequently, whenever the particular channel is chosen, the saved user defined display parameters will be applied to the display, overriding the factory-specified default display modes corresponding to the detected type of signal received (HDTV vs. SDTV, and other foreign standards).

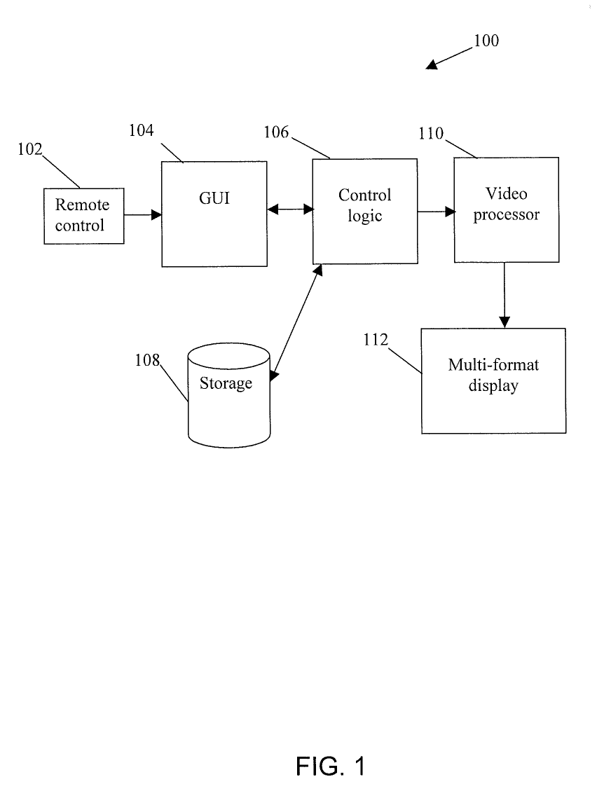

FIG. 1 illustrates an exemplary system 100 for implementing an embodiment of the invention. The system 100 may be part of a set top box, or directly integrated into a display housing. A viewer enters display aspect ratios for individual channels and video inputs utilizing a GUI 104. The GUI 104 may be displayed on the viewing screen 112, and accept commands via a remote control device 102. The GUI 104 interacts with the control logic 106 for deriving available control options including the choices for available display aspect ratios. The control logic 106 may be in the form of firmware, an integrated circuit, or a combination thereof. The control logic 106 interacts with a non-volatile storage medium 108 to store and retrieve viewer parameters that have been entered with the GUI 104. The non-volatile storage medium 108 may take different forms including magnetic storage, or flash memory. The flash memory may be in the form of insertable memory sticks or may be integrated with the control logic 106. The control logic 106 provides instructions to a video processor to control the video on the multi-format display 112. The multi-format display 112 is configured for presenting the various aspect ratios per the stored viewer parameters, default parameters, or an aspect ratio as determined by the broadcaster or the signal source.

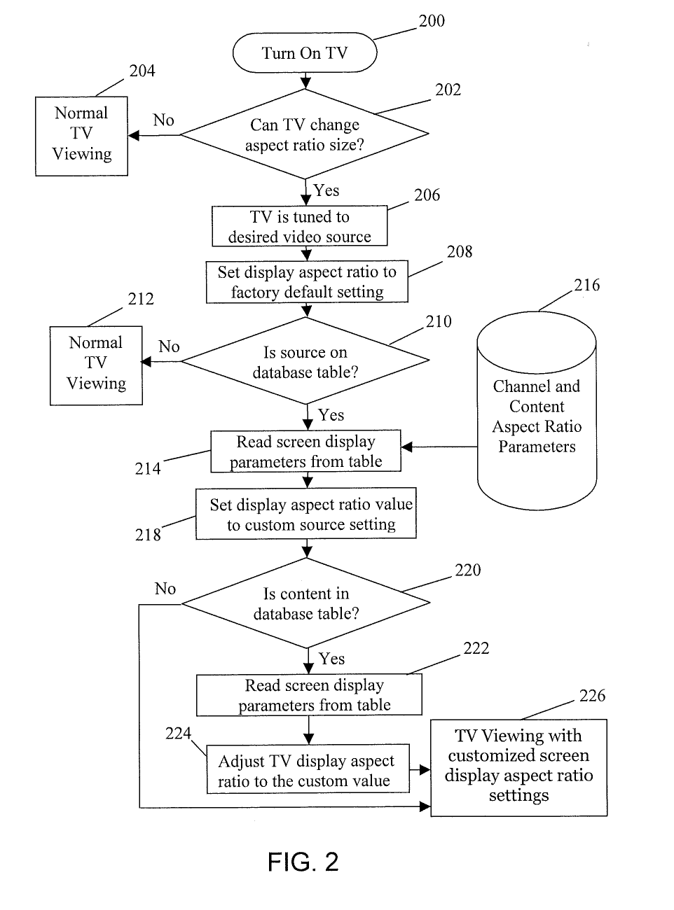

FIG. 2 is a flowchart illustrating the selection of viewer defined display aspect ratios based on predefined parameters in a non-volatile database according to embodiments of the invention. The selection of an aspect ratio starts with the viewer turning on the display monitor, which in this example is a TV (block 200). If the TV can not change aspect ratios (decision block 202 is No), the predefined aspect ratio for the TV is displayed and normal TV viewing occurs (block 204). However, if the TV is configured to display multiple aspect ratio sizes (decision block 202 is Yes), and the viewer tunes to a desired channel or input from an external video source, for example a DVD player or other player of pre-recorded video content (both are hereafter referred to in combination as a video source) (block 206), the video source is initially displayed to a factory default aspect ratio setting (block 208). In response to the selected video source, the TV control logic then determines if the viewer has defined an aspect ratio for the selected video source (decision block 210). If the viewer has not defined an aspect ratio for the video source (decision block 210 is No), the predefined aspect ratio for the TV is displayed and normal TV viewing occurs (block 212).

Continuing with the example embodiment of FIG. 2, if the viewer has defined an aspect ratio for the video source (decision block 210 is Yes), the control logic reads the display parameters from a table (block 214) stored in non-volatile storage 216, and sets the display aspect ratio to the viewers customized source setting (block 218). If certain content, such as sports, movies, or news, has a user defined aspect ratio in the table (decision block 220 is Yes), the control logic reads the display parameters from a table (block 222) stored in non-volatile storage 216, and sets the display aspect ratio to the viewers customized content setting (block 224). TV viewing then proceeds with the customized screen display aspect ratio settings (block 226).

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for viewer based control of video display aspect ratios, the method comprising:
applying an initial video display aspect ratio to a selected signal source;
determining whether the selected signal source has a viewer assigned video display aspect ratio;
modifying the initial video display aspect ratio of the selected signal source in response to the viewer assigned video display aspect ratio;
wherein the viewer assigned video display aspect ratio is a subset of one or more of the viewer assigned video display aspect ratios that are stored in a non-volatile memory medium;
wherein the one or more viewer assigned video display aspect ratios are each individually associated with a signal source; and
wherein a viewer assigned video display aspect ratio is retrieved from the non-volatile memory medium in response to the selection of an associated signal source.

2. The method of claim 1, wherein the signal source is a television channel.

3. The method of claim 1, wherein the signal source is an input signal from an external video source.

4. The method of claim 1, wherein the one or more viewer assigned video display aspect ratios are inputted through a graphical user interface (GUI).

5. The method of claim 1, wherein the one or more viewer assigned video display aspect ratios are stored in a database in the form of a table.

6. The method of claim 1, wherein the one or more viewer assigned video display aspect ratios are based on content.

7. An article comprising one or more computer-readable storage media containing instructions that when executed by a computer enables viewer based control of video display aspect ratios; wherein the method further comprises:
applying an initial video display aspect ratio to a selected signal source;
determining whether the selected signal source has a viewer assigned video display aspect ratio;
modifying the initial video display aspect ratio of the selected signal source in response to the viewer assigned video display aspect ratio;
wherein the viewer assigned video display aspect ratio is a subset of one or more of the viewer assigned video display aspect ratios that are stored in a non-volatile memory medium;
wherein the one or more viewer assigned video display aspect ratios are each individually associated with a signal source; and
wherein a viewer assigned video display aspect ratio is retrieved from the non-volatile memory medium in response to the selection of an associated signal source.

8. The article of claim 7, wherein the signal source is a television channel.

9. The article of claim 7, wherein the signal source is an input signal from an external video source.

10. The article of claim 7, wherein the one or more viewer assigned video display aspect ratios are inputted through a graphical user interface (GUI).

11. The article of claim 7, wherein the one or more viewer assigned video display aspect ratios are stored in a database in the form of a table.

12. The article of claim 7, wherein the one or more viewer assigned video display aspect ratios are based on content.

13. A system configured for viewer based control of video display aspect ratios, the system comprising:
a video display configured for showing multiple aspect ratios and a graphical user interface;
control logic in communication with a non-volatile storage medium;
wherein the control logic is configured to:
apply an initial video display aspect ratio to a selected signal source;
determine whether the selected signal source has a viewer assigned video display aspect ratio;
modify the initial video display aspect ratio of the selected signal source in response to the viewer assigned video display aspect ratio;
wherein the viewer assigned video display aspect ratio is a subset of one or more of the viewer assigned video display aspect ratios that are stored in the non-volatile storage medium;
wherein the one or more viewer assigned video display aspect ratios are each individually associated with a signal source; and
wherein a viewer assigned video display aspect ratio is retrieved from the non-volatile storage medium in response to the selection of an associated signal source.

14. The system of claim 13, wherein the signal source is a television channel.

15. The system of claim 13, wherein the signal source is an input signal from an external video source.

16. The system of claim 13, wherein the one or more viewer assigned video display aspect ratios are inputted through the graphical user interface (GUI).

17. The system of claim 13, wherein the one or more viewer assigned video display aspect ratios are stored in a database in the form of a table.

18. The system of claim 13, wherein the one or more viewer assigned video display aspect ratios are based on content.

19. The system of claim 13, wherein the non-volatile storage medium includes, but is not limited to magnetic storage or flash memory; and
wherein the flash memory is in the form of at least one of the following:
an insertable memory stick, and integrated with the control logic.

20. The system of claim 13, wherein the control logic is in the form of at least one of the following: an integrated circuit, firmware, and a combination of firmware and integrated circuits.
